(19) United States
(12) Patent Application Publication
(10) Pub. No.: US 2025/0330459 A1
(43) Pub. Date: Oct. 23, 2025

(54) SERVICE PROVISION SYSTEM AND METHOD WHICH USE USER ACCESS TOKEN

(71) Applicant: AWESOMEBLY, INC., Seoul (KR)

(72) Inventors: Kyungsik KIM, Gwangmyeong-si (KR); Mun Hwan BAE, Siheung-si (KR)

(21) Appl. No.: 19/254,028

(22) Filed: Jun. 30, 2025

Related U.S. Application Data
(63) Continuation of application No. PCT/KR2024/000067, filed on Jan. 2, 2024.

(30) Foreign Application Priority Data
Dec. 30, 2022 (KR) 10-2022-0191194
May 25, 2023 (KR) 10-2023-0067946
May 25, 2023 (KR) 10-2023-0067947
Jan. 2, 2024 (KR) 10-2024-0000177
Jan. 2, 2024 (KR) 10-2024-0000178

(51) Int. Cl. H04L 9/40

(52) U.S. Cl. CPC H04L 63/083; H04L 63/0281

(57) ABSTRACT

Disclosed is a service provision system using a user access token including a user terminal used for a user to request a service and use the service provided from a service server, an access control server configured to provide a one-time user access token including information necessary for the user to use the service and allowing the user terminal to access the service server for a unit session, and a gateway configured to provide data provided from the service server to the user terminal between the user terminal and the service server, and a service is provided without exposing an address of the service server.

### TECHNICAL FIELD

The present invention relates to a service provision system using a user access token, and more particularly to a service provision system capable of preventing information exposure of a server through reverse connection with a dynamic port based on a user access token at a gateway that provides data between a user and the server.

### BACKGROUND ART

Recently, due to advancement of information and communication technology, development of information provision technology has been actively conducted to provide information on various fields in real time to a large number of subscribers through at least one service provision server via a data communication network.

Meanwhile, information security technology has been actively developed so that, when a user attempts to access the service provision server using a computer terminal to perform communication, the service provision server serves as a protected server, and a security system is applied thereto to protect the service provision server by a security server.

In addition, in order to secure access to in-house information servers, etc. used in corporations or financial institutions, permissions need to be restricted in detail by user, task, or role, and loop-around connection needs to be blocked.

In general, when a user requests access using a specific protocol such as SSH (secure shell), TELNET, or RDP (remote desktop protocol), an access port for such a protocol is statically set, and access is performed through the access port.

However, access is made through such a common default port, there is a problem of being vulnerable to hacking through port scanning or scanning using PING.

In particular, there has been a problem in that, after accessing a certain service server among a plurality of service servers, loop around connection is possible from the certain service server to another service server.

### DISCLOSURE

### Technical Problem

The present invention has been made in view of the above problems, and it is an object of the present invention to provide an information and communication service provision system capable of providing an information and communication service without exposing an address of a service server to a user through reverse connection using a dynamic port and a one-time user access token for a user using the service.

It is another object of the present invention to provide an information and communication service provision system which operates independently of existing security devices such as a firewall and VPN, and in which loop around connection from a certain service server to another service server is impossible.

### Technical Solution

An aspect of the present invention to achieve the above object is a service provision system using a user access token, including a user terminal used for a user to request a service and use the service provided from a service server, an access control server configured to provide a one-time user access token including information necessary for the user to use the service and allowing the user terminal to access the service server for a unit session, and a gateway configured to provide data provided from the service server to the user terminal between the user terminal and the service server, wherein the gateway includes a first gateway for access to the user terminal, and a second gateway for access to the service server, and data provided from the service server is transmitted to the user terminal by a communication channel established from the second gateway to the first gateway by the second gateway.

In the service provision system using the user access token according to an embodiment of the present invention, the one-time user access token may include user authentication information (AuthToken) proving that the user is an authenticated user, device authentication information (DeviceToken) proving that the user terminal is an authenticated device, server access authentication information (AccessToken) proving that the user is a user authorized to access the server, and valid period authentication information (EffectiveToken) proving that the one-time user access token is a valid token.

In addition, the user authentication information may be generated by being encoded using a user ID, an access time, and a unique value for each user.

Further, the device authentication information may be generated by being encoded using a device-specific ID.

In addition, the server access authentication information may be generated by being encoded using a service ID, user information, an authentication time, and a unique key for each service server.

Further, the valid period authentication information may be information on an elapsed time after issuance that limits validity of the one-time user access token after a preset time by counting the preset time during issuance of the one-time user access token.

In addition, data transmission between the first gateway and the second gateway may be performed exclusively in a reverse direction from the second gateway on a side of the service server to the first gateway on a side of the user terminal.

Further, the user terminal may transmit authentication request information to the access control server to request provision of a one-time user access token, and the access control server may generate a one-time user access token based on the authentication request information and transmit the one-time user access token to the user terminal.

In addition, the authentication request information may include user information which is information on a user using the user terminal, device information which is unique information of the user terminal, and server access information which is information on access to the service server.

Further, the user terminal may request service usage from the first gateway based on the one-time user access token transmitted from the access control server, and the first gateway may request, from the access control server, authentication of the one-time user access token received from the user terminal.

In addition, when a one-time user access token transmitted from the first gateway coincides with a one-time user access token previously transmitted to the user terminal, the access control server may be configured to set a first dynamic port and a second dynamic port in the first gateway and the second gateway, respectively, to establish a channel between the first gateway and the second gateway, and transmit, to the second gateway, an address and a port of a service server from which the service usage has been requested.

Further, the access control server may provide setting content of the first dynamic port and the second dynamic port to the second gateway.

In addition, the second gateway may request access to the service server using the address and the port of the service server provided from the access control server.

Further, the second gateway may access the first dynamic port of the first gateway using the second dynamic port.

In addition, the access control server may update and generate the first dynamic port or the second dynamic port periodically according to a preset condition.

Further, the preset condition may be new access of the user terminal.

In addition, the preset condition may be a capacity of data transmitted from the second dynamic port to the first dynamic port exceeding a preset data amount.

Further, when a service used by a specific user needs to be blocked, the access control server may release dynamic port setting of the second gateway.

In addition, the server access authentication information may include an expiration time (ExpireDate), which is information about a server access validity time.

Further, the expiration time may be set to be longer as a security level of a device increases according to the device authentication information.

In addition, according to a security level of the service server, the expiration time may be set to be shorter as the security level increases.

Further, the one-time user access token may include validity information indicating whether the one-time user access token is valid.

In addition, the validity information may include a limited data amount so that the access control server is allowed to discard the one-time user access token when a preset data capacity is provided according to an amount of data provided by the gateway to the user terminal.

### Advantageous effects

The service provision system using the one-time user access token according to the present invention provides only gateway information to the user through reverse connection with a dynamic port based on the one-time user access token at the gateway that provides data between the user and the server, so that there is an effect that server information on the service being used is not exposed to the user, thereby completely blocking hacking.

In addition, according to the present invention, since the dynamic port of the first gateway on the user terminal side and the dynamic port of the second gateway on the service server side are updated and generated each time the user accesses the service server, there is an effect of being able to safely protect the gateway from hacking and information leakage.

In particular, according to the present invention, data transmission between the first gateway and the second gateway is performed only in a reverse direction from the second gateway on the service server side to the first gateway on the user terminal side, so that there is an effect of being able to fundamentally block external intrusion.

In addition, according to the present invention, through the use of the one-time user access token generated differently depending on conditions (time and session), even when information is exposed, the information becomes unusable after a period of time has passed, so that there is an effect of being able to safely protect server information.

In addition, according to the present invention, there is an effect of being able to provide only authorized content to the user through filtering and reconfiguration based on a user network profile for each service.

In addition, according to the present invention, a plurality of access channels is set with respect to the service server according to security levels, and a service is provided by allocating a channel according to a security level of the user, so that there is an effect of being able to provide a differentiated service according to the user and content.

Meanwhile, according to the invention, since the user terminal is connected to the gateway through a proxy integration server, there is an effect of being able to prevent leakage of gateway connection information.

In addition, according to the present invention, data uploaded or downloaded between the user terminal and the service server is uploaded/downloaded after verifying whether the data is contaminated by a virus and whether leakage is permitted using a DLP solution module, so that there is an effect of being able to ensure stability and security of the system.

### DESCRIPTION OF DRAWINGS

FIG. 1 is a block diagram of a service provision system using a user access token according to the present invention;

FIG. 2 is a flow diagram illustrating an order of providing a service by the system of the present invention;

FIG. 3 is a flow diagram illustrating a detailed process of a method of providing the service by the system of the present invention;

FIG. 4 is an example diagram of a configuration of authentication request information and a one-time user access token according to the present invention;

FIG. 5 is a block diagram illustrating a detailed configuration of the service provision system using the user access token according to the present invention;

FIG. 6 is a block diagram of a service provision system including devices for providing a service according to a second embodiment of the present invention;

FIG. 7 is a block diagram illustrating an order of providing a service by each device according to the second embodiment of the present invention;

FIG. 8 is a block diagram illustrating a content reconfiguration method according to the second embodiment of the present invention;

FIG. 9 is a block diagram of a service provision system for providing a service according to a server access control method according to a third embodiment of the present invention;

FIG. 10 is a block diagram illustrating an order of providing a service by each device according to a server access control method according to the third embodiment of the present invention;

FIG. 11 is a block diagram illustrating a relationship between a user security level and channel allocation according to the third embodiment of the present invention;

FIG. 12 is a block diagram of a service provision system using a user access token according to a fourth embodiment of the present invention; and

FIG. 13 is a block diagram of a service provision system using a user access token according to a fifth embodiment of the present invention.

### BEST MODE

The present invention for the best mode includes a user terminal used for a user to request a service and use the service provided from a service server, an access control server configured to provide a one-time user access token including information necessary for the user to use the service and allowing the user terminal to access the service server for a unit session, and a gateway configured to provide data provided from the service server to the user terminal between the user terminal and the service server, wherein the gateway includes a first gateway for access to the user terminal, and a second gateway for access to the service server, and data provided from the service server is transmitted to the user terminal by a communication channel established from the second gateway to the first gateway by the second gateway.

### Mode for Invention

The present invention may be modified in various ways and may have various implementations, and specific embodiments are illustrated in the drawings and described in detail. However, this is not intended to limit the present invention to specific embodiments, and it should be understood that all modifications, equivalents, and substitutes included in the spirit and technical scope of the present invention are encompassed. In describing the present invention, when it is determined that a specific description of a related known technology may obscure the gist of the present invention, the detailed description thereof will be omitted.

The present invention relates to a service provision system using a one-time user access token capable of preventing information exposure of a server through reverse connection with a dynamic port based on the one-time user access token at a gateway that provides data between a user and the server.

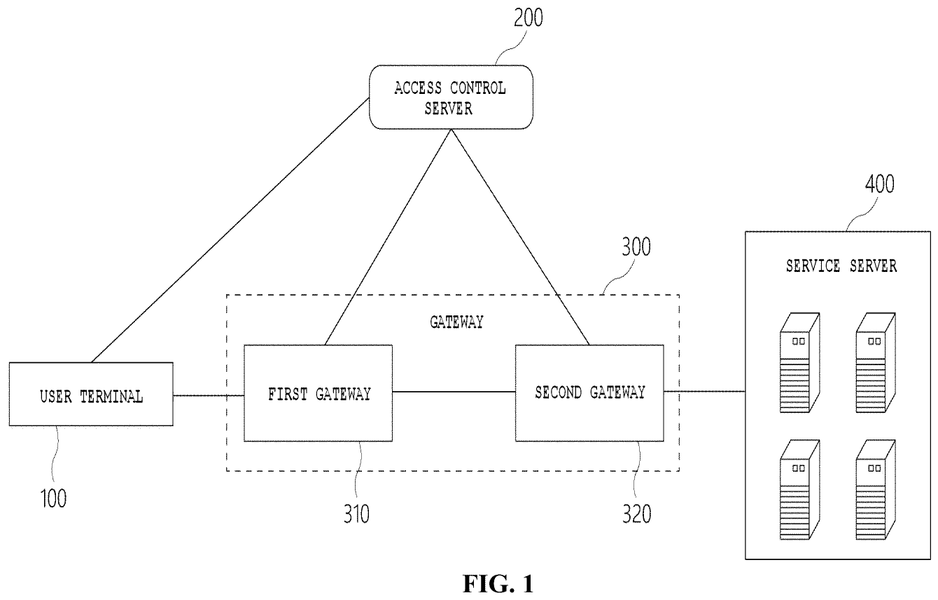

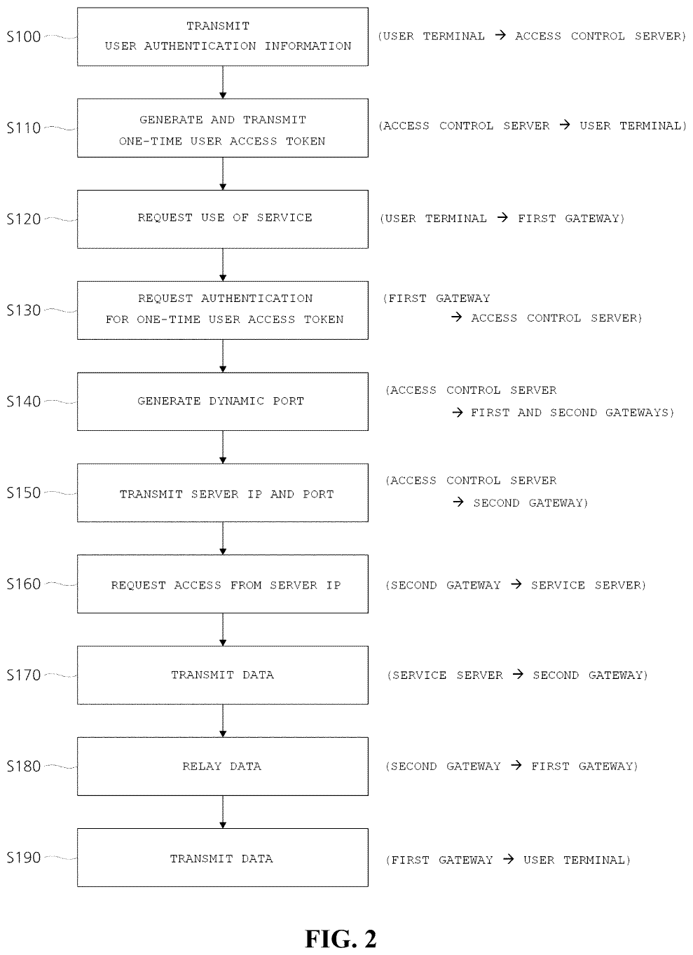

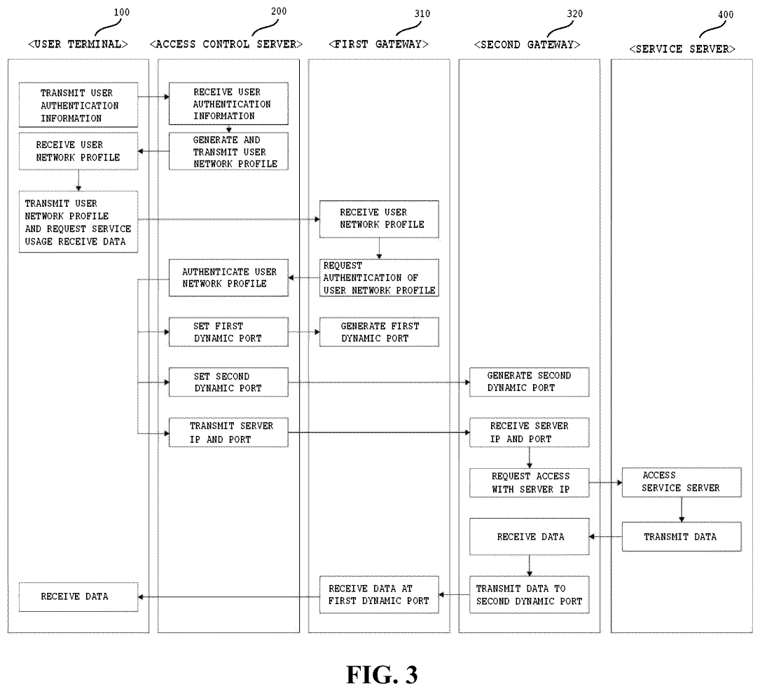

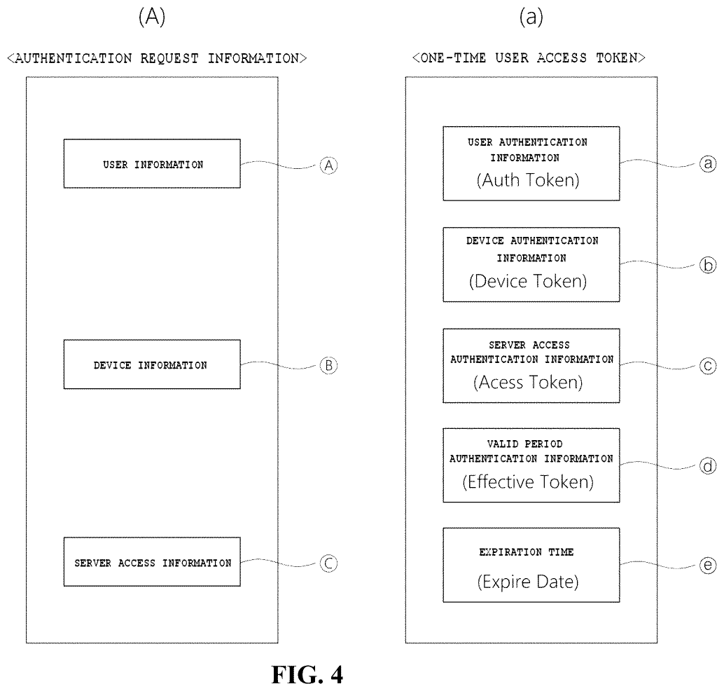

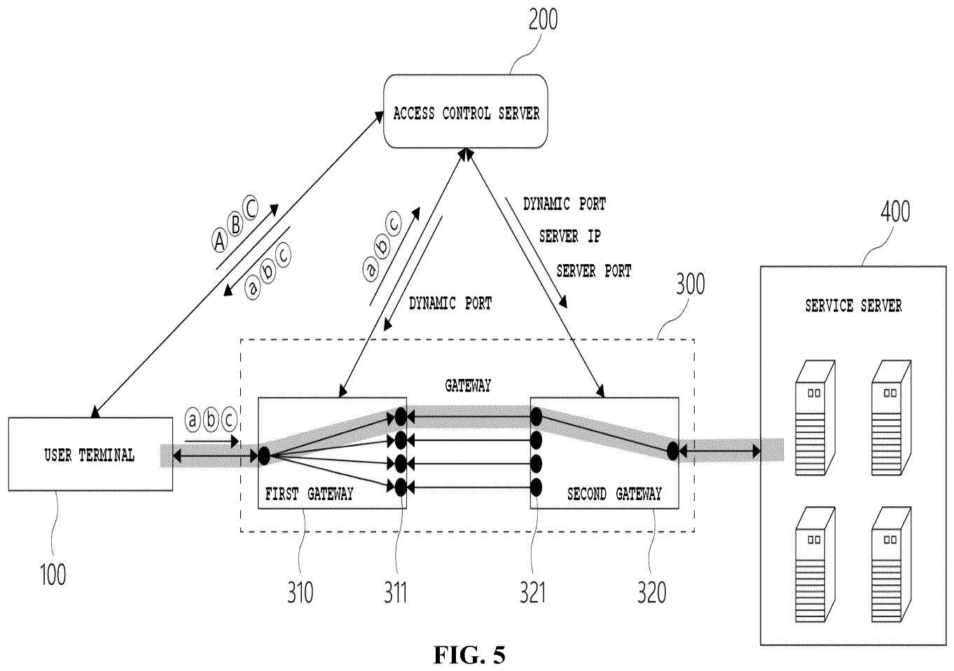

Hereinafter, a service provision system using a one-time user access token of the present invention will be described in more detail with reference to preferred embodiments and the attached drawings. In this regard, FIG. 1 is a block diagram of the service provision system using the user access token according to the present invention, FIG. 2 is a flow diagram illustrating an order of providing a service by the system of the present invention, FIG. 3 is a flow diagram illustrating a detailed process of a method of providing the service by the system of the present invention, FIG. 4 is an example diagram of a configuration of authentication request information and a one-time user access token according to the present invention, and FIG. 5 is a block diagram illustrating a detailed configuration of the service provision system using the user access token according to the present invention.

First, referring to FIG. 1, the service provision system using the one-time user access token of the present invention may broadly include a user terminal 100, an access control server 200, a gateway 300, a service server 400, and a database 500.

The user terminal 100 is a device for a user to request a one-time user access token, which is authentication information for service usage qualification, by transmitting authentication request information to the access control server 200, and request a service from the gateway 300 when the service usage qualification is authenticated, to use a service provided from the service server 400. Examples of the user terminal 100 include a PC (Personal Computer) or a mobile phone, but are not limited thereto, and may include various information and communication devices capable of accessing a server of a service operator through a wired/wireless communication network.

The access control server 200 is a main server of the service operator and performs a function of generating a one-time user access token, which is information on service usage qualification required to request a service from the gateway 300, and providing the one-time user access token to the user terminal 100. Accordingly, access of the user to the service server 400 requiring security is controlled, and access to the gateway 300, such as connection request and connection termination for the gateway 300, is controlled.

The access control server 200 may be configured in conjunction with the database 500, and the database 500 performs a function of storing and updating various data required for the system of the present invention to provide an information and communication service and providing the data to the access control server 200.

The gateway 300 may include a first gateway 310 for access to the user terminal 100 and a second gateway 320 for access to the service server 400.

Here, the system of the present invention is characterized by being configured so that data transmission between the first gateway 310 and the second gateway 320 is performed only in a reverse direction from the second gateway 320 on the service server 400 side to the first gateway 310 on the user terminal 100 side.

That is, data provided from the service server 400 is transmitted to the user terminal 100 by a communication channel formed from the second gateway 320 to the first gateway 310.

Therefore, according to the present invention, the gateway 300 excludes direct connection between the user terminal 100 and the service server 400, thereby preventing information about the service server 400 from being directly exposed to the user, while providing data provided from the service server 400 to the user terminal 100. A detailed function of the gateway 300 will be described in more detail later.

The service server 400 is a server for providing a service desired to be used by the user, and may be configured to collectively include a plurality of servers requiring security depending on the type of service used by the user.

Hereinafter, a method of providing a service in the service provision system using the one-time user access token according to the present invention will be described in more detail with reference to FIGS. 2 to 5.

In order to use the service of the present invention, first, the user transmits authentication request information to the access control server 200 using the user terminal 100 to request a one-time user access token, which is authentication information for service usage qualification (S100).

In this instance, the one-time user access token is generated each time a user terminal is connected, but the one-time user access token may be replaced with a user network profile fixedly issued to the user, excluding one-time use.

Hereinafter, in this specification, the user network profile has the same configuration as that of the one-time user access token, performs the same function, and is not generated only for one-time usage. User network profile and user access token are used interchangeably.

Next, the access control server 200 receiving the authentication request information authenticates information included in the authentication request information based on information in the database 500, generates a one-time user access token, and then transmits the one-time user access token to the user terminal (S110).

Here, the authentication request information required to request authentication as to whether the user has the legitimate qualification to use the service may include user information A, which is personal information about the user using the user terminal 100, device information B, which is unique information about the user terminal 100, and server access information C, which is information about access to the service server 400.

The user information A may include, for example, information such as a name, an affiliation, and a position of the user. The device information B may include a unique device ID. In addition, the server access information C may include content of the service desired to be used by the user.

In the present invention, when the user has the legitimate qualification to use the service, the provided one-time user access token may include user authentication information (AuthToken) proving that the user is an authenticated user, device authentication information (DeviceToken) proving that the user terminal 100 is an authenticated device, server access authentication information (AccessToken) proving that the user is a user authorized to access the server, and valid period authentication information (EffectiveToken) proving that the one-time user access token is a valid token.

In this instance, the user authentication information (AuthToken) is generated in an encrypted form by being encoded using a user ID, an access time, and a unique value for each user.

Further, the device authentication information (DeviceToken) is generated in an encrypted form using CPU Id, HDD Id, MAC Address, etc. in the case of a PC, and is generated in an encrypted form using a device-specific ID in the case of other devices.

In addition, the server access authentication information (AccessToken) is generated in an encrypted form by being encoded using a service ID, user information, an authentication time, and a unique key for each service server.

Meanwhile, the valid period authentication information (EffectiveToken) may be information on an elapsed time after issuance that limits validity of the one-time user access token after a preset time by counting the preset time during issuance of the one-time user access token.

Accordingly, according to the present invention, since access is possible only when information about users, servers, and terminals is transmitted and received in an encrypted form, an authenticated user (AuthToken) has authority to access (AccessToken) the server from an authenticated device (DeviceToken), and one-time user access token is valid (EffectiveToken), it is possible to fundamentally block a user without service usage qualification from accessing the server.

Hereinafter, a description will be given of a step in which a user whose service usage qualification is authenticated requests a request, receives data, and uses a service.

First, the user receiving the one-time user access token as described above uses the user terminal 100 to transmit the one-time user access token to the first gateway 310, thereby requesting a service (S120).

As described above, when the user requests a service from the first gateway 310 using the user terminal 100, the first gateway 310 first transmits the one-time user access token received from the user terminal 100 to the access control server 200 to request authentication for the one-time user access token (S130).

As described above, the access control server 200 receiving the one-time user access token performs authentication therefor. That is, when the received one-time user access token coincides with the one-time user access token previously transmitted to the user terminal 100, the access control server 200 sets a first dynamic port 311 in the first gateway 310 and sets a second dynamic port 321 in the second gateway 320 (S140).

In this instance, the access control server 200 provides setting content of the first dynamic port 311 and the second dynamic port 321 to the second gateway 320, so that connection is established from the second dynamic port 321 of the second gateway 320 to the first dynamic port 311 of the first gateway 310. At the same time, the access control server 200 transmits an address and a port of a service server, from which the service usage has been requested, to the second gateway 320 (S150).

Here, the first dynamic port 311 refers to a variable port for access to the user terminal 100 side, and the second dynamic port 321 refers to a variable port for access to the service server 400 side.

Then, the second gateway 320 requests connection from the service server 400 using the address of the service server transmitted from the access control server 200 (S160). Thereafter, when access to the service server 400 is made using the server address, the service server 400 transmits data to the second gateway 320 (S170).

In this instance, the second gateway 320 receives data through the second dynamic port 321 and relays the received data to the first dynamic port 311 of the first gateway 310 (S180). In addition, the first gateway 310 provides and transmits the data received through the first dynamic port 311 to the user terminal 100 (S190), thereby providing a service.

That is, in the present invention, a communication channel between the first gateway 310 and the second gateway 320 is established by the second gateway 320 requesting the communication channel from the first gateway 310, and the communication channel is not formed by the first gateway 310.

That is, the present invention is configured so that data transmission between the first gateway 310 and the second gateway 320 is performed only in one direction from the second dynamic port 321 of the second gateway 320 to the first dynamic port 321 of the first gateway 310, and information about the second gateway 320 is not provided to the first gateway 310, so that the first gateway 310 cannot form a communication channel with the second gateway 320.

Accordingly, data provided from the service server 400 is only transmitted through the gateway 300, instead of being directly transmitted to the user terminal 100, and address or port information of the service server 400 is provided to the user only through the gateway 300, so that the user terminal 100 cannot directly form a communication channel with the service server 400. Therefore, server information about the service being used is not exposed to the user, so that hacking may be completely blocked.

According to an embodiment of the present invention, the access control server 200 may update and generate the first dynamic port 311 or the second dynamic port 321 periodically according to a preset condition.

For example, the access control server 200 may newly generate the first dynamic port 311 or the second dynamic port 321 each time the user terminal 100 accesses the access control server 200. Therefore, since a separate dynamic port is used each time the user terminal 100 accesses the server, the gateway 300 may be safely protected by blocking hacking and information leakage.

In addition, the preset condition may be a case where a capacity of data transmitted from the second dynamic port 321 to the first dynamic port 311 exceeds a preset data amount. That is, since a new dynamic port is generated and data is transmitted after the user receives a predetermined amount of data, even when the existing port information is leaked, the port information cannot be continuously used.

In this instance, when a service used by a specific user needs to be blocked, the access control server 200 may release the dynamic port setting of the second gateway 320 to stop data transmission. In this way, it is possible to control abnormal access.

Therefore, according to the present invention, since the data provided by the service server 400 is only transmitted through the gateway 300, instead of being directly transmitted to the user terminal 100, only information of the gateway 300 is provided to the user, so that server information about the service being used is not exposed to the user, and thus hacking may be completely blocked.

In particular, since the present invention updates and generates the first dynamic port 311 of the first gateway 310 and the second dynamic port 321 of the second gateway 320 according to a preset condition, the gateway may be safely protected from hacking and information leakage. In addition, even when the port information is leaked, the port information cannot be continuously used.

In this instance, data transmission between the first gateway 310 and the second gateway 320 is performed only in the reverse direction from the second gateway 320 on the service server side to the first gateway 310 on the user terminal side, and thus it is possible to fundamentally block external intrusion.

According to another embodiment of the present invention, the server access authentication information of the one-time user access token may include an expiration time (ExpireDate), which is information about a server access validity time.

Therefore, the service is used for a permitted time by controlling an expiration time when using the service. Thus, even when information is exposed, only temporary use is possible due to continuous change.

In particular, according to this embodiment, the expiration time may be set to be longer as the security level of the device increases according to the device authentication information. In addition, the expiration time may be set to be shorter as the security level of the service server 400 increases.

For example, when using a service by accessing a server where confidentiality is important, a service usage time may be set to be short and a user authentication procedure may be frequently performed, thereby minimizing information leakage to the service server 400 where security is important. In addition, in the case of a device such as a mobile phone with poor security, the expiration time may be set to be short, and in the case of a device such as a business computer thoroughly equipped with a security function, the expiration time may be set to be long.

According to another embodiment of the present invention, the one-time user access token may include validity information indicating whether the one-time user access token is valid.

In this instance, the validity information may include a limited data amount so that the access control server 200 may discard the one-time user access token when a preset data capacity is provided according to the amount of data provided by the gateway 300 to the user terminal 100. That is, connection is interrupted after the user receives a predetermined amount of data, and the user needs to enter new authentication request information to continue the connection.

Accordingly, according to the present invention, access to the server is controlled using a one-time user access token generated differently according to conditions (time and data amount). Therefore, even when the server information is exposed, access to the server becomes impossible under a set condition, that is, in response to exceeding a set time or amount of data. Thus, even when the server information is temporarily exposed, continuous usage is impossible.

Hereinafter, a method of providing a service using a user access token according to a second embodiment of the present invention will be examined with reference to the attached drawings.

In describing additional embodiments below, duplicate descriptions will be omitted.

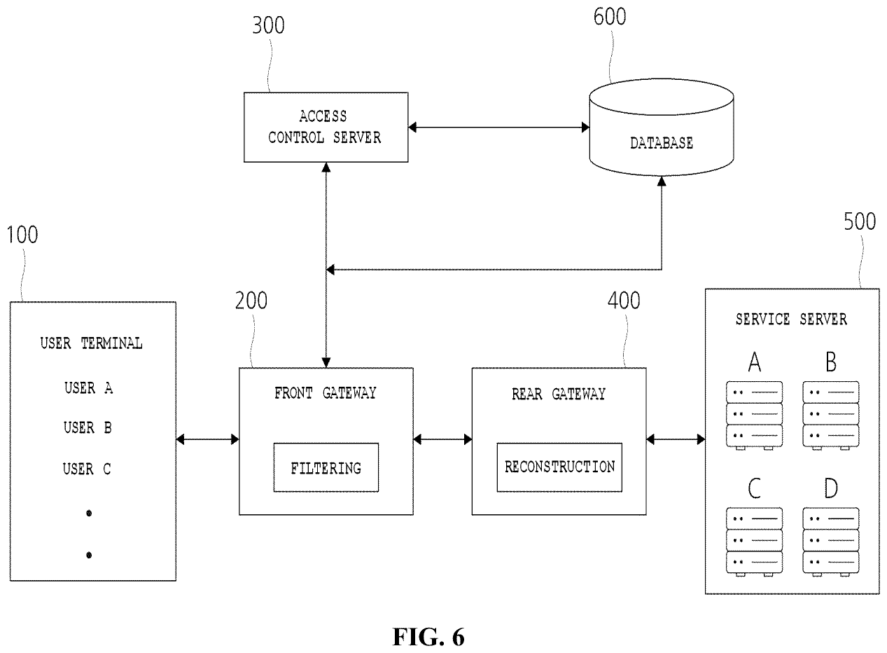

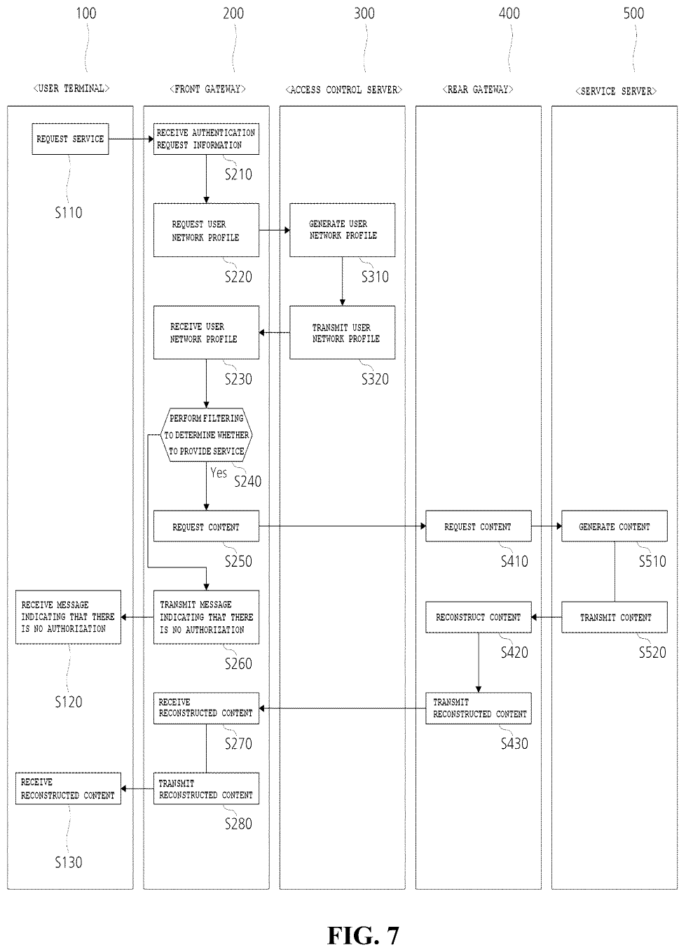

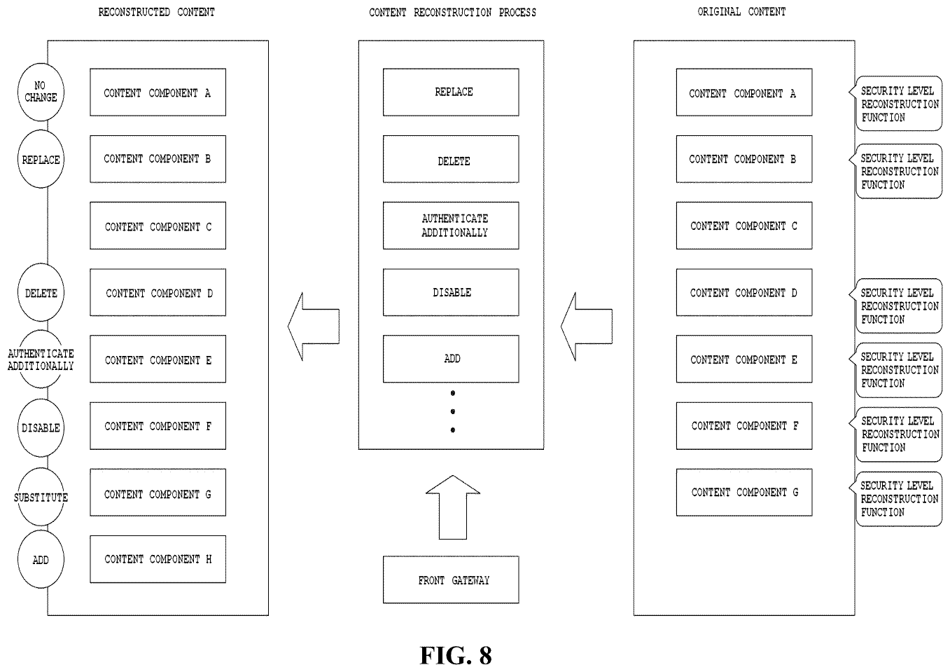

FIG. 6 is a block diagram of a service provision system including devices for providing the service according to the second embodiment of the present invention, FIG. 7 is a block diagram illustrating an order of providing the service by each device according to the second embodiment of the present invention, and FIG. 8 is a block diagram illustrating a content reconfiguration method according to the second embodiment of the present invention.

First, as illustrated in FIG. 6, a method of providing authorized content based on a user network profile according to the second embodiment of the present invention may be provided by a service provision system including a user terminal 100, a front gateway 200, an access control server 300, a rear gateway 400, a service server 500, and a database 600.

In this instance, the front gateway 200 and the rear gateway 400 have the same configuration as those of the first gateway and the second gateway described above, respectively.

Meanwhile, in the present invention, the term service is a complex concept that includes data requested by the user, that is, content, and various functions such as viewing, copying, and printing of the content.

The service server 500 is a server for providing a service desired to be used by the user, and a plurality of servers requiring security may be collectively configured according to a type of service used by the user.

Meanwhile, as illustrated in FIGS. 7 and 8, the method of providing authorized content based on the user network profile according to the second embodiment of the present invention may basically include a step (A) of requesting, by the user terminal, a service from the front gateway 200 (Front Access Gateway), a step (B) of requesting, by the front gateway 200, a user network profile from the access control server 300 (Management Server), a step (C) of generating the user network profile by the access control server 300 and transmitting the user network profile to the front gateway 200, a step (D) of performing filtering, by the front gateway 200, to determine whether to provide the requested service based on the user network profile, a step (E) of requesting, by the front gateway 200, content only for the filtered service request from the rear gateway 400 (Backend Access Gateway), a step (F) of requesting, by the rear gateway 400, content from the service server 500, a step (G) of transmitting content from the service server 500 to the rear gateway 400, a step (H) of reconstructing, by the rear gateway 400, the transmitted content into a form that may be provided according to the user network profile, and a step (I) of transmitting, by the rear gateway 400, the reconstructed content to the user terminal through the front gateway 200.

Each step of this method will be described. First, the user requests service usage by transmitting authentication request information to the front gateway 200 using the user terminal 100 (S110).

Next, the front gateway 200 receiving the authentication request information (S210) transmits the received authentication request information to the access control server 300 to request generation of a user network profile (S220). Accordingly, the access control server 300 authenticates the information included in the authentication request information based on the information in the database 600 to generate a user network profile (S310), and then transmits the user network profile back to the front gateway 200 (S320).

Next, the front gateway 200 receiving the user network profile (S230) performs filtering to determine whether to provide the requested service based on the user network profile (S240). This step is a process of determining whether the service request is an authorized service request based on the user authentication information and the device authentication information included in the user network profile.

For example, content that may be provided only to a certain user may be set based on the user authentication information, and functions such as viewing, copying, and printing of the content may be restricted depending on the user. In addition, the content and type of the service may be restricted depending on the device authentication information, that is, whether the device is a universally usable mobile phone or a personal computer that is available only in a special security environment.

Therefore, when the service request of the user is determined to be unauthorized through the filtering step, the front gateway 200 transmits a message indicating that there is no authorization to the user terminal 100 (S260).

Then, the front gateway 200 requests service provision from the rear gateway 400 (Backend Access Gateway) only for the filtered service (S250). In addition, the rear gateway 400 from which service provision has been requested accesses the service server 500 to request a service (S410), and the service server 500 generates content (S510) and transmits the content to the rear gateway 400 (S520).

In addition, the rear gateway 400 performs a reconstruction task for the content transmitted from the service server 500 (S420). The content reconstruction task may include replacing (REPLACE), deleting (DELETE), disabling (DISABLE), or adding (ADDITION) part or all of the content according to the service authentication information as illustrated in FIG. 4.

That is, only allowed content is provided by replacing, deleting, or adding part or all of the content according to the security level of each user.

Therefore, according to the present invention, only the allowed content may be provided according to the security level of the user through filtering and reconstruction for each user and/or service based on the user network profile.

In the present invention, the front gateway 200 may generate an access port for accessing the user terminal 100 as a dynamic port. Here, the dynamic port may be updated and set each time the front gateway 200 is connected to the user terminal 100.

In addition, the rear gateway 400 may generate an access port for accessing the service server 500 as a dynamic port. Here, the dynamic port may be updated and set each time the rear gateway 400 is connected to the service server 500.

Therefore, according to the present invention, since separate dynamic ports are used each time the front gateway 200 and the user terminal 100 are interconnected and the rear gateway 400 and the service server 500 are interconnected, the gateways 200 and 400 may be safely protected by blocking hacking and information leakage.

In particular, since a service provided by the service server 500 is not directly transmitted to the user terminal 100 but only through the gateways 200 and 400, only information of the gateways 200 and 400 is provided to the user. Accordingly, according to the present invention, server information on the service being used is not exposed to the user, so that hacking may be completely blocked.

Meanwhile, according to an embodiment of the present invention, the user network profile may include an expiration time (ExpireDate), which is information about a valid period of the user network profile.

Therefore, since the service is used for an allowed amount of time and continuously changed through control of the expiration time when using the service, even when the user network profile is leaked, if an unauthorized terminal (user) accesses the front gateway 200 through the leaked user network profile in the future, the access may be blocked due to expiry of the expiration time.

In particular, according to this embodiment, the expiration time may be set to be shorter as the security level of the service server 500 increases. For example, when accessing a server where confidentiality is important and using the service, a service usage time may be set to be short and a user authentication procedure may be frequently performed, so that access to the server may be restricted as much as possible for the service server 500 whose security is important.

According to another embodiment of the present invention, the user network profile may include validity information indicating whether the user network profile is valid.

In this instance, the validity information may be session information indicating an access session. The session information may be newly set and updated, for example, each time the user accesses the access control server 300.

Here, the session may be set for each access target service server 500 of the user terminal 100, may be set for each connection/disconnection unit of the user terminal 100, and may be set for a preset work unit.

In addition, the validity information may include a limited data amount so that the access control server 300 may discard the corresponding user network profile when a preset data capacity is provided according to the amount of data provided by the front gateway 200 to the user terminal 100. In other words, after the user receives predetermined data, connection is interrupted, and the user needs to input new authentication request information to continue the connection.

That is, even when an unauthorized terminal (user) accesses the gateway through a leaked user network profile in the future, when a large amount of data is received, a re-authorization process is performed according to the limited data amount, thereby preventing a large amount of data leakage.

In addition, the preset data capacity may be set differently depending on the security level and/or work class of the user.

For example, a user of a work class (security level) that receives data from the service server 500 and processes the data may minimize inconvenience in performing work by increasing the set data capacity, and a majority of users of a work class (security level) that mainly views data from the corresponding service server 500 may minimize the set data capacity, thereby maximizing security.

Accordingly, according to the present invention, since access to the server is controlled using a user network profile that is differently generated according to conditions (time, data amount, and session), even when the user network profile is exposed, it becomes impossible to access the server therethrough when a set condition, i.e., a set time, data volume, or session has elapsed, and thus it becomes impossible to continuously access the service server 500 therethrough.

Hereinafter, a method of providing a service using a user access token according to a third embodiment of the present invention will be described with reference to the attached drawings.

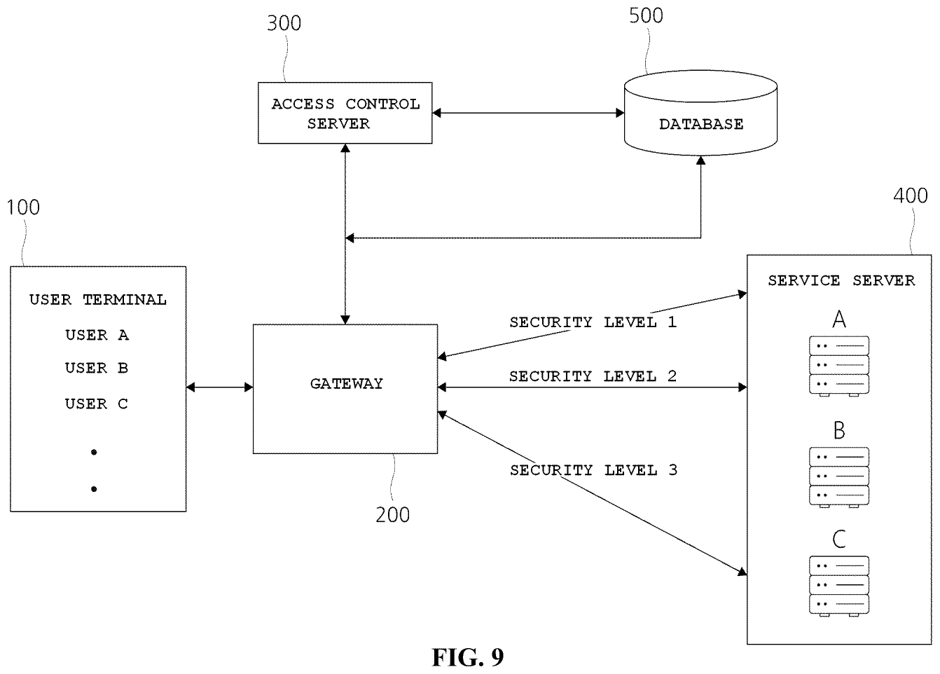

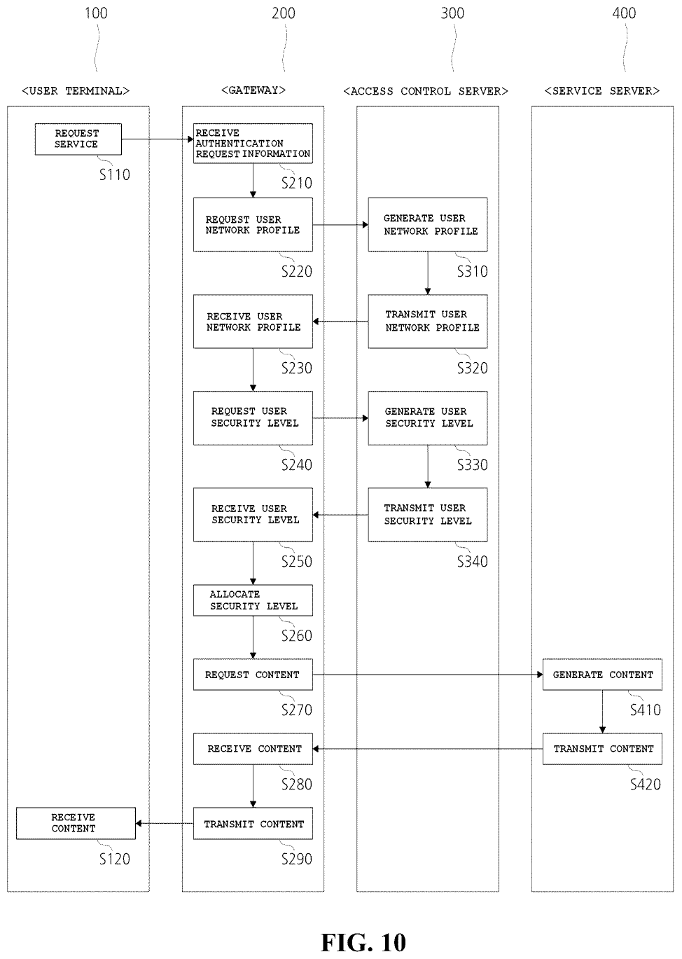

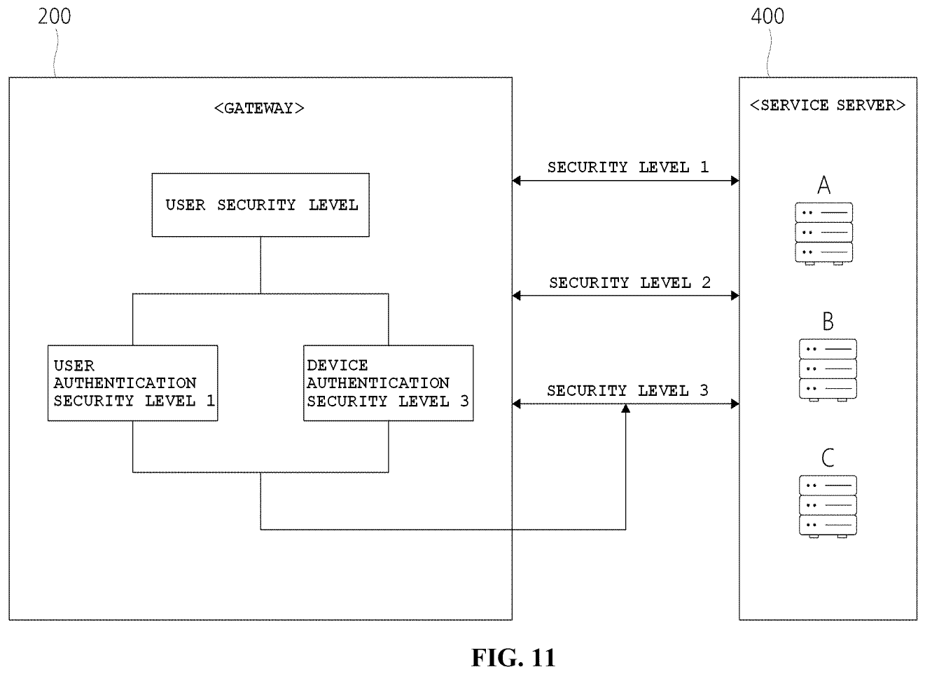

FIG. 9 is a block diagram of a service provision system for providing a service according to a server access control method according to the third embodiment of the present invention, FIG. 10 is a block diagram illustrating an order of providing a service by each device according to a server access control method according to the third embodiment of the present invention, and FIG. 11 is a block diagram illustrating a relationship between a user security level and channel allocation according to the third embodiment of the present invention.

First, as illustrated in FIG. 9, the method of providing the service using the user access token according to the third embodiment of the present invention is performed by a system that includes a service provision system including a user terminal 100, a gateway 200, an access control server 300, a service server 400, and a database 500.

Specifically, as illustrated in FIGS. 10 and 11, the method of providing the service using the user access token according to the third embodiment of the present invention basically includes a step (A) of requesting, by the user terminal 100, a service from the front gateway 200, a step (B) of requesting, by the gateway 200, a user network profile, which is authentication required for the user to use a service, from the access control server 300 (Management Server), a step (C) of generating, by the access control server 300, a user network profile and transmitting the user network profile to the gateway 200, a step (D) of accessing the service server 400 from the gateway 200, a step (E) of providing content from the service server 400 to the gateway 200, and a step (F) of transmitting content from the gateway 200 to the user terminal 100.

First, the user requests service usage by transmitting authentication request information to the gateway 200 using the user terminal 100 (S110).

Then, the gateway 200 receiving the authentication request information (S210) transmits the received authentication request information to the access control server 300 to request generation of a user network profile (S220). Accordingly, the access control server 300 authenticates information included in the authentication request information has a legitimate qualification based on information in the database 500 to generate a user network profile (S310), and then transmits the user network profile back to the gateway 200 (S320).

According to an embodiment of the present invention, connection between the gateway 200 and the service server 400 is performed by allocating a security level channel corresponding to a user security level according to the user network profile among a plurality of security level channels classified by security level, and connection with the service server 400 is performed through the corresponding security level channel.

In the present invention, the security level channel may have a bandwidth set differently according to the security level, so that as the security level increases, a greater maximum data transmission amount is ensured.

In addition, the security level channel may have a communication priority for each channel set differently according to the security level, so that as the security level increases, more stable communication is ensured.

In order to allocate the security level channel as described above, the gateway 200 transmits the user network profile to the access control server 300 to request a security level for the user (S240), and the access control server 300 generates a security level for the user based on information of the user network profile (S330) and transmits the security level to the gateway 200 (S340).

Next, the gateway 200 receiving the security level for the user (S250) allocates a security level channel corresponding to the user security level (S260).

Here, as illustrated in FIG. 11, the user security level is set to a separate security level for each of the user authentication information and the device authentication information, and a security level channel corresponding to a lower security level among security levels of the user authentication information and the device authentication information is allocated to the user.

For example, as illustrated in FIG. 11, when the security level of the user authentication information is level 1 and the security level of the device authentication information is level 3, a channel corresponding to security level 3 is allocated to the user.

When the security level channel is allocated as described above, the gateway 200 accesses the service server 400 through the allocated security level channel to request content (S270). When the service server 400 is accessed through the security level channel, the service server 400 generates requested content (S410) and transmits the content to the gateway 200 (S420).

Subsequently, the gateway 200 receiving the content transmitted from the service server 400 (S280) relays and transmits the content to the user terminal 100, thereby providing a service.

In this way, according to the present invention, by setting a plurality of access channels between the gateway and the service server according to security levels and allocating a channel according to a security level of the user to provide the service, there is an effect of being able to provide a differentiated service according to the security level of the user.

Hereinafter, a service provision system using a user access token according to a fourth embodiment of the present invention will be examined with reference to the attached drawings.

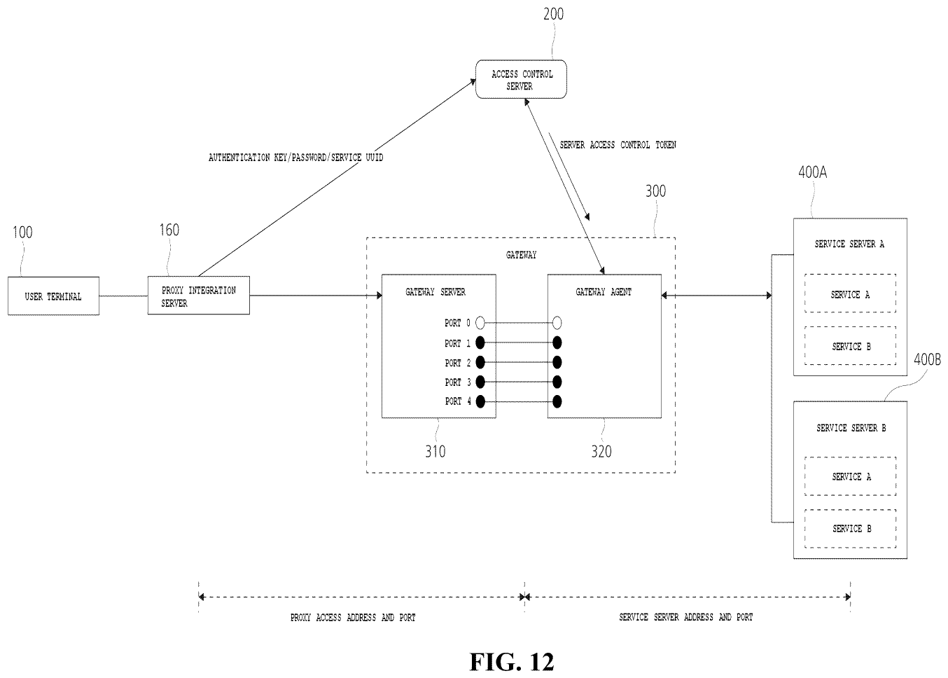

As illustrated in FIG. 12, the service provision system using the user access token according to the fourth embodiment of the present invention is an embodiment in which a proxy integration server 160 is further provided in the embodiment described in FIG. 5, etc.

That is, in the case of the fourth embodiment of the present invention illustrated in FIG. 12, a technical configuration for accessing the server through reverse connection with a dynamic port based on a one-time user access token is basically the same except for the proxy integration server 160.

However, unlike the above-described embodiment, the user terminal 100 accesses the gateway 300 through the proxy integration server 160.

In this instance, the first gateway has the same meaning as a gateway server, the second gateway has the same meaning as a gateway agent, and the gateway may be a proxy gateway (or proxy server).

In this way, the user terminal 100 accesses the proxy integration server 160 and requests data to be provided from the service server 400, and the proxy integration server 160 receives the requested data from the gateway 300 and provides the data to the user terminal 100.

That is, since the user terminal 100 does not directly access the gateway 300, even when the user terminal 100 is hacked, only access information for the proxy integration server 160 is exposed, and access information for the gateway 300 may be prevented from being exposed.

In this instance, channels established between a port of the gateway server and a port of the gateway agent may be divided into a control channel (port 0) for transmitting and receiving control data necessary for channel setup and a data channel (ports 1, 2, . . . ) for transmitting data provided from the service server.

Meanwhile, although not shown, in the case of each embodiment of the present invention, a plurality of gateways may be provided in parallel.

In this case, when an operational error is detected in any of the gateways, the access control server 200 allocates a new gateway to a user using the corresponding gateway.

That is, when an operational error is detected in the gateway, the access control module 200 reallocates an unoccupied data channel of a normally operating gateway to the corresponding user so that the corresponding user may continue to receive a service from the service server 400.

Furthermore, the access control module 200 may allocate a spare data channel to the user in preparation for an operational error of the gateway.

In this instance, considering physical limitations of data channels, a spare data channel may be allocated to a user having a high security level. The security level may be a security level of the user acquired from user authentication information or a device security level acquired from device authentication information.

That is, the access control module 200 may allocate one or more of unoccupied data channels of the gateways as a spare channel according to a security level of the user among users to whom the data channels of the gateways are allocated.

Accordingly, in the case of a user having a high security level, even when an operation error of the gateway occurs while receiving a service from the service server, the service may be continuously provided without service interruption.

Hereinafter, a service provision system using a user access token according to a fifth embodiment of the present invention will be examined with reference to the attached drawings.

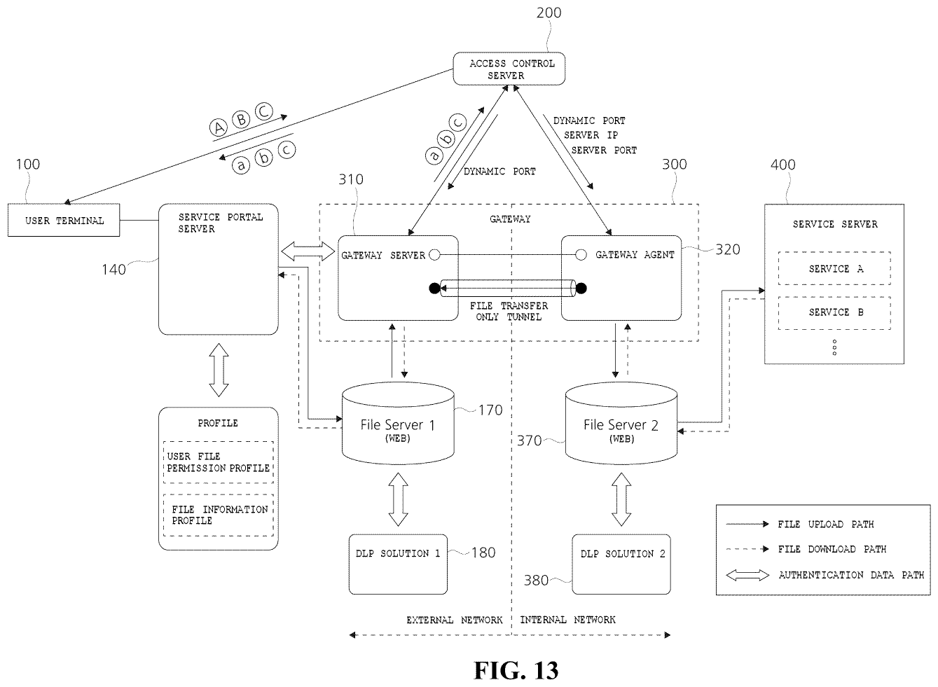

As illustrated in FIG. 13, the service provision system using the user access token according to the fifth embodiment of the present invention further includes a service portal server 140, file servers 170 and 370, and DLP solution modules 180 and 380 in the embodiments described in FIG. 5, etc. However, the technical configuration for access to the server through reverse connection with a dynamic port based on the one-time user access token is the same.

However, unlike the above-described embodiments, in the case of this embodiment, the user terminal 100 is connected to the gateway 300 through the service portal server 140.

In this instance, the first gateway has the same meaning as a gateway server, the second gateway has the same meaning as a gateway agent, and the gateway may be a proxy gateway (or a proxy server).

Accordingly, the user terminal 100 accesses the service portal server 140 to request data to be provided from the service server 400, and the service portal server 140 receives the requested data from the gateway 300 and provides the requested data to the user terminal 100.

That is, since the user terminal 100 does not directly access the gateway 300, even when the user terminal 100 is hacked, only access information for the service portal server 140 is exposed, and access information for the gateway 300 is prevented from being exposed.

In this instance, channels established between a port of the gateway server 310 and a port of the gateway agent 320 may be divided into a control channel (port 0) for transmitting and receiving control data required for channel setup and a data channel (ports 1, 2, . . . ) for transmitting data provided from the service server.

Meanwhile, data (authentication data, etc.) for user authentication, channel setup and control, etc. are directly transmitted and received between the service portal server 140 and the gateway 300 and between the service server 400 and the gateway 300.

On the other hand, data uploaded from the user terminal 100 to the service server 400 and data downloaded from the service server 400 to the user terminal 100 are relayed through the file servers 170 and 370.

In addition, the data relayed from the file servers 170 and 370 is verified by the DLP solution module 180 and 380 to determine whether the data is contaminated or leaked.

Specifically, as illustrated in FIG. 4, the file server includes a first file server 170 provided between the service portal server 140 and the gateway server 310 to relay data uploaded from the user terminal 100 to the service server 400, and a second file server 370 provided between the service server 400 and the gateway agent 320 to relay data downloaded from the service server 400 to the user terminal 100.

In addition, the DLP solution module includes the first DLP solution module 180 that verifies whether data relayed by the first file server 170 is contaminated by a virus.

In this way, among data uploaded and stored in the service server 400, data contaminated by a virus, etc. is prevented from being uploaded, so that stability of the service server 400 may be ensured.

In addition, the DLP solution module includes the second DLP solution module 380 that verifies whether data relayed by the second file server 370 is permitted to leak to the corresponding user terminal 100.

In this way, security according to the security level may be ensured for data downloaded from the service server 400 to the user terminal 100.

In this instance, verification of whether leakage is permitted by the second DLP solution module 380 may be determined by the one-time user access token of the user, and specifically, verification may be determined based on the security level of the user identified through the one-time user access token.

Even though the preferred embodiments of the present invention have been described above, those with common knowledge in the relevant technical field will be able to modify and change the present invention in various ways by adding, changing, deleting or adding components within the scope not deviating from the spirit of the present invention described in the patent claims, and this will also be encompassed within the scope of the rights of the present invention.

### Industrial Applicability

The present invention relates to a service provision system capable of preventing information exposure of a server through reverse connection with a dynamic port based on a one-time user access token at a gateway that provides data between a user and the server. According to the present invention, data transmission between a first gateway and a second gateway is performed only in a reverse direction from the second gateway on a service server side to the first gateway on a user terminal side, thereby having an effect of being able to fundamentally block external intrusion.

1. A service provision system using a user access token, the service provision system comprising:
a user terminal used for a user to request a service and use the service provided from a service server;
an access control server configured to provide a one-time user access token including information necessary for the user to use the service and allowing the user terminal to access the service server for a unit session; and
a gateway configured to provide data provided from the service server to the user terminal between the user terminal and the service server, wherein:
the gateway comprises:
a first gateway for access to the user terminal; and
a second gateway for access to the service server, and
data provided from the service server is transmitted to the user terminal by a communication channel established from the second gateway to the first gateway by the second gateway.

2. The service provision system according to claim 1, wherein the one-time user access token comprises:
user authentication information (AuthToken) proving that the user is an authenticated user;
device authentication information (DeviceToken) proving that the user terminal is an authenticated device;
server access authentication information (AccessToken) proving that the user is a user authorized to access the server; and
valid period authentication information (EffectiveToken) proving that the one-time user access token is a valid token.

3. The service provision system according to claim 2, wherein the user authentication information is generated by being encoded using a user ID, an access time, and a unique value for each user.

4. The service provision system according to claim 3, wherein the device authentication information is generated by being encoded using a device-specific ID.

5. The service provision system according to claim 4, wherein the server access authentication information is generated by being encoded using a service ID, user information, an authentication time, and a unique key for each service server.

6. The service provision system according to claim 5, wherein the valid period authentication information is information on an elapsed time after issuance that limits validity of the one-time user access token after a preset time by counting the preset time during issuance of the one-time user access token.

7. The service provision system according to claim 2, wherein data transmission between the first gateway and the second gateway is performed exclusively in a reverse direction from the second gateway on a side of the service server to the first gateway on a side of the user terminal.

8. The service provision system according to claim 7, wherein:
the user terminal transmits authentication request information to the access control server to request provision of a one-time user access token, and
the access control server generates a one-time user access token based on the authentication request information and transmits the one-time user access token to the user terminal.

9. The service provision system according to claim 8, wherein the authentication request information comprises:
user information which is information on a user using the user terminal;
device information which is unique information of the user terminal; and
server access information which is information on access to the service server.

10. The service provision system according to claim 9, wherein:
the user terminal requests service usage from the first gateway based on the one-time user access token transmitted from the access control server, and
the first gateway requests, from the access control server, authentication of the one-time user access token received from the user terminal.

11. The service provision system according to claim 10, wherein, when a one-time user access token transmitted from the first gateway coincides with a one-time user access token previously transmitted to the user terminal, the access control server is configured to:
set a first dynamic port and a second dynamic port in the first gateway and the second gateway, respectively, to establish a channel between the first gateway and the second gateway, and
transmit, to the second gateway, an address and a port of a service server from which the service usage has been requested.

12. The service provision system according to claim 11, wherein the access control server provides setting content of the first dynamic port and the second dynamic port to the second gateway.

13. The service provision system according to claim 12, wherein the second gateway requests access to the service server using the address and the port of the service server provided from the access control server.

14. The service provision system according to claim 13, wherein the second gateway accesses the first dynamic port of the first gateway using the second dynamic port.

15. The service provision system according to claim 14, wherein the access control server updates and generates the first dynamic port or the second dynamic port periodically according to a preset condition.

16. The service provision system according to claim 15, wherein the preset condition is new access of the user terminal.

17. The service provision system according to claim 16, wherein the preset condition is a capacity of data transmitted from the second dynamic port to the first dynamic port exceeding a preset data amount.

18. The service provision system according to claim 17, wherein, when a service used by a specific user needs to be blocked, the access control server releases dynamic port setting of the second gateway.

19. The service provision system according to claim 18, wherein the server access authentication information comprises an expiration time (ExpireDate), which is information about a server access validity time.

20. The service provision system according to claim 19, wherein the expiration time is set to be longer as a security level of a device increases according to the device authentication information.

21. The service provision system according to claim 20, wherein, according to a security level of the service server, the expiration time is set to be shorter as the security level increases.

22. The service provision system according to claim 21, wherein the one-time user access token comprises validity information indicating whether the one-time user access token is valid.

23. The service provision system according to claim 22, wherein the validity information comprises a limited data amount so that the access control server is allowed to discard the one-time user access token when a preset data capacity is provided according to an amount of data provided by the gateway to the user terminal.

24. A method of providing a service using a user access token, the method comprising steps of:
(A) requesting, by a user terminal, a service from a front gateway (Front Access Gateway);
(B) requesting, by the front gateway, a user network profile, which is authentication requested for a user to use the service, from an access control server (Management Server);
(C) generating, by the access control server, a user network profile and transmitting the user network profile to the front gateway;
(D) performing filtering, by the front gateway, to determine whether to provide the requested service based on the user network profile;
(E) requesting, by the front gateway, content exclusively for a filtered service request from the rear gateway (Backend Access Gateway);
(F) requesting, by the rear gateway, content from a service server;
(G) transmitting content from the service server to the rear gateway;
(H) reconstructing, by the rear gateway, the transmitted content into a form allowed to be provided according to the user network profile; and
(I) transmitting, by the rear gateway, the reconstructed content to the user terminal through the front gateway.

25. The method according to claim 24, wherein the step (B) comprises transmitting, by the front gateway, authentication request information transmitted from the user terminal to the access control server to request provision of the user network profile.

26. A method of providing a service using a user access token, the method comprising steps of:
(A) requesting, by a user terminal, a service from a gateway;
(B) requesting, by the gateway, a user network profile, which is authentication required for a user to use the service, from an access control server (Management Server);
(C) generating, by the access control server, a user network profile and transmitting the user network profile to the gateway;
(D) accessing a service server by the gateway;
(E) providing content from the service server to the gateway; and
(F) transmitting content from the gateway to the user terminal,
wherein the step (D) comprises allocating a security level channel corresponding to a user security level according to the user network profile among a plurality of security level channels classified by security level, and performing connection through the security level channel.

27. The method according to claim 26, wherein the step (B) is performed by the gateway transmitting authentication request information transmitted from the user terminal to the access control server to request provision of the user network profile.

28. The method according to claim 27, wherein:
the step (C) is performed by the access control server comparing information included in the authentication request information with information stored in a database to generate a user network profile, and
the authentication request information comprises:
user information which is information on a user using the user terminal;
device information which is unique information of the user terminal; and
server access information which is information on access to the service server.

29. The method according to claim 24, wherein the user network profile comprises:
user authentication information (AuthToken) proving that the user is an authenticated user;
device authentication information (DeviceToken) proving that the user terminal is an authenticated device;
server access authentication information (AccessToken) proving that the user is a user authorized to access the server; and
service authentication information (ServiceToken) on a service allowed to be provided to the user from the server.

30. The method according to claim 29, wherein:
the user authentication information (AuthToken) is generated by being encoded using a user ID, an access time, and a unique value for each user;
the device authentication information (DeviceToken) is generated by being encoded using a device-specific ID; and
the server access authentication information (AccessToken) is generated by being encoded using a service ID, user information, an authentication time, and a unique key for each service server.

31. The method according to claim 30, wherein the service authentication information (ServiceToken) is generated by encoding permitted service content for each content type according to a security level for each user distinguished by user authentication information and device authentication information.

32. The method according to claim 24, wherein the step (D) comprises determining whether the service request is an authorized service request based on user authentication information and device authentication information included in the user network profile.

33. The method according to claim 32, wherein content reconstruction of the step (H) comprises replacing (REPLACE), deleting (DELETE), disabling (DISABLE), or adding (ADDITION) part or all of content according to service authentication information.

34. The method according to claim 33, wherein an access port of the user terminal of the front gateway is generated as a dynamic port and is updated and set each time a connection is made from the front gateway to the user terminal.

35. The method according to claim 34, wherein an access port of the service server of the rear gateway is generated as a dynamic port and is updated and set each time a connection is made from the rear gateway to the service server.

36. The method according to claim 28, wherein the security level channel has a bandwidth set differently according to a security level, so that as the security level increases, a greater maximum data transmission amount is ensured.

37. The method according to claim 36, wherein the security level channel has a communication priority for each channel set differently according to a security level, so that as the security level increases, more stable communication is ensured.

38. The method according to claim 37, wherein the user security level is set to a separate security level for each of user authentication information and device authentication information.

39. The method according to claim 38, wherein a security level channel corresponding to a lower security level among security levels of the user authentication information and the device authentication information is allocated as a security level channel corresponding to the user security level.

40. The method according to claim 30, wherein an access port of the user terminal of the gateway is generated as a dynamic port and is updated and set each time a connection is made from the gateway to the user terminal.

41. The method according to claim 40, wherein an access port of the service server of the gateway is generated as a dynamic port and is updated and set each time a connection is made from the gateway to the service server.

42. The method according to claim 41, wherein the user network profile comprises an expiration time (ExpireDate), which is information about a validity time of the user network profile.

43. The method according to claim 42, wherein, according to a security level of the service server, the expiration time is set to be shorter as the security level increases.

44. The method according to claim 43, wherein the user network profile comprises validity information indicating whether the user network profile is valid.

45. The method according to claim 44, wherein the validity information is session information indicating an access session.

46. The method according to claim 45, wherein the validity information comprises a limited data amount so that the access control server is allowed to discard the user network profile when a preset data capacity is provided according to an amount of data provided by the gateway to the user terminal.

47. A service provision system using a user access token, the service provision system comprising:
a user terminal used for a user to request a service and use the service provided from a service server;
a gateway configured to transmit data provided from the service server to provide the data to the user terminal;
a proxy integration server configured to relay between the user terminal and the gateway, receive service request information from the user terminal, receive data provided from the service server through the gateway, and transmit the data to the user terminal; and
an access control server configured to provide a one-time user access token including information necessary for the user to use the service and allowing the proxy integration server to access the service server for a unit session, wherein:
the gateway comprises:
a gateway server for access to the proxy integration server; and
a gateway agent for access to the service server, and
data provided from the service server is transmitted to the user terminal through the proxy integration server by a communication channel established from the gateway agent to the gateway server by the gateway agent.

48. The service provision system according to claim 47, wherein:
the user terminal transmits authentication request information to the access control server to request provision of a one-time user access token;
the access control server generates a one-time user access token based on the authentication request information and transmits the one-time user access token to the user terminal;
the user terminal requests service usage from the proxy integration server based on the one-time user access token transmitted from the access control server;
the proxy integration server transmits usage request content of the user terminal and the one-time user access token to the gateway server; and
the gateway server requests, from the access control server, authentication of the one-time user access token received from the proxy integration server.

49. A service provision system using a user access token, the service provision system comprising:
a user terminal used for a user to request a service and use the service provided from a service server;
a gateway configured to transmit data provided from the service server to provide the data to the user terminal;
a service portal server configured to relay between the user terminal and the gateway, receive service request information from the user terminal, receive data provided from the service server through the gateway, and transmit the data to the user terminal;
an access control server configured to provide a one-time user access token including information necessary for the user to use the service and allowing the service portal server to access the service server for a unit session;
a file server provided between the gateway and the service portal server or the service server to relay data uploaded or downloaded from the user terminal; and
a DLP solution module configured to verify whether uploaded data and downloaded data relayed by the file server is contaminated or allowed to leak, wherein:
the gateway comprises:
a gateway server for access to the service portal server; and
a gateway agent for access to the service server, and
data provided from the service server is transmitted to the user terminal through the service portal server by a communication channel established from the gateway agent to the gateway server by the gateway agent.

50. The service provision system according to claim 49, wherein:
the file server comprises:
a first file server provided between the service portal server and the gateway server to relay data uploaded from the user terminal to the service server; and
a second file server provided between the service server and the gateway agent to relay data downloaded from the service server to the user terminal, and
the DLP solution module comprises:
a first DLP solution module configured to verify whether data relayed by the first file server is contaminated by a virus; and
a second DLP solution module configured to verify whether data relayed by the second file server is permitted to leak based on the one-time user access token.

51. The service provision system according to claim 50, wherein:
the user terminal transmits authentication request information to the access control server to request provision of a one-time user access token;
the access control server generates a one-time user access token based on the authentication request information and transmits the one-time user access token to the user terminal;
the user terminal requests service usage from the service portal server based on the one-time user access token transmitted from the access control server;
the service portal server transmits usage request content of the user terminal and the one-time user access token to the gateway server; and
the gateway server requests, from the access control server, authentication of the one-time user access token received from the service portal server.

52. The service provision system according to claim 47, wherein the communication channel established between the gateway agent and the gateway server comprises:
a plurality of data channels through which data is transmitted; and
a control channel for transmitting control data for allocating the data channels to each user terminal according to a one-time user access token.

53. The method according to claim 26, wherein the user network profile comprises:
user authentication information (AuthToken) proving that the user is an authenticated user;
device authentication information (DeviceToken) proving that the user terminal is an authenticated device;
server access authentication information (AccessToken) proving that the user is a user authorized to access the server; and
service authentication information (ServiceToken) on a service allowed to be provided to the user from the server.
